(19) United States
(12) Patent Application Publication
(10) Pub. No.: US 2009/0189450 A1
(43) Pub. Date: Jul. 30, 2009

(54) DUAL-CHANNEL LOAD SWITCH CIRCUITS, DEVICES INCLUDING A DUAL-CHANNEL LOAD SWITCH CIRCUIT AND METHODS OF SWITCHING LOAD CHANNELS

(75) Inventor: Qi Deng, San Jose, CA (US)

Correspondence Address: Dorsey & Whitney LLP;US Bank Center, 1420 Fifth Avenue, Suite 3400, Seattle, WA, 98101-4010, US

(73) Assignee: Micrel, Incorporated, San Jose, CA (US)

(21) Appl. No.: 12/022,196

(22) Filed: Jan. 30, 2008

(51) Int. Cl. H02J 9/00

(52) U.S. Cl. 307/64

(57) ABSTRACT

A dual-channel load switch circuit may be provided for switching between first and second sources that generate respective input voltages. The circuit may include first and second channels adapted to receive the respective input voltages and to supply respective output voltages to a load element based on the respective input voltages. The first and second channels may each include first and second switching elements and first and second control circuitry. The second channel may include a diode in parallel with the second switching element and may be coupled to the first control circuitry. The circuit may include a reservoir element coupled to the first and second channels and configured to store a potential when one of the first and second channels supplies a respective output voltage to the load element and to apply the potential to the load element when neither output voltage is being supplied to the load element.

### BACKGROUND

The inventive filed relates generally to switch circuits and methods for switching between power sources for a device. The inventive field also relates to dual-channel load switch circuits, devices including such circuits and methods of switching load channels.

Switching circuits and methods for switching between power sources for a device are generally well known. For example, such circuits and methods may be applied to devices such as mobile phones, personal digital assistants (PDAs) and personal media players to allow power to be supplied by an AC power source, such as an AC adaptor when available and to allow power to be supplied by battery when the AC power source is not available.

In general, known switching circuits and methods are designed to operate the particular device as long as the input voltage from the AC or battery power source is above a preset value or threshold to allow a load or load element of the device to be powered efficiently. If only one power source is connected to the device and the voltage from the power source drops below the threshold, the power source may be disconnected from the load element and the device may be shut down. If both power sources are connected to the device, only one of the power sources should be connected to the load element at any given time. For example, the power source with a higher output voltage, typically the AC source, may be connected to the load element with the other power source, often, for example, the battery, disconnected from the load element. If the AC power source becomes lower than the preset value, or the AC source becomes disconnected from the device or disconnected from the wall socket, the battery may be connected to the load element.

One approach to switching power sources is to employ two channels that may be switched, for example, coupled and decoupled, to provide power to the load element of a device. FIG. 1 schematically illustrates an example of such an approach that is currently available in the market. As illustrated therein, an AC power source 2, such as an adaptor, is connected to a first channel 4 of the device and a DC power source 6, such as a battery, is connected to a second channel 8 of the device. The first and second channels 4, 8 may include first and second switches 10, 12, or Q1, Q2, respectively, that are operated by respective gate drives 14, 16, for example, to connect and disconnect the power sources 2, 6. A microcontroller 18 may be connected to monitor the voltages of the power sources 2, 6 and to independently control the gate drives 14, 16 to turn on/off the first and second switches 10, 12 through enable signals EN1 and EN2, based on the voltages and availability of the power sources 2, 6, as discussed above.

### SUMMARY

In general, a dual-channel load switch circuit may be provided for switching between first and second sources serving as a power supply to a load element and generating respective first and second input voltages. The dual-channel load switch circuit may include a first channel adapted to receive the first input voltage and to supply a first output voltage to the load element based on the first input voltage and a second channel adapted to receive the second input voltage and to supply a second output voltage to the load element based on the second input voltage. The first channel may include a first switching element and first control circuitry for controlling the first switching element. The second channel may include a second switching element, a diode in parallel with the second switching element and second control circuitry for controlling the second switching element. The second control circuitry may be coupled to the first control circuitry. A reservoir element may be coupled to the first and second channels and configured to store a potential when one of the first and second channels supplies a respective first and second output voltage to the load element and to apply the potential to the load element when neither of the first and second output voltages is being supplied to the load element.

Also, a portable device may be provided including a dual-channel load switch circuit for switching between first and second sources serving as a power supply and generating respective first and second inputs. The portable device may include a load element, a first channel adapted to receive the first input and configured to be coupled to the load element based on the first input and a second channel adapted to receive the second input and configured to be coupled to the load element based on the first input and the second input. The first channel may include a first switching element and first control circuitry for controlling the first switching element. The second channel may include a second switching element, a diode in parallel with the second switching element and second control circuitry for controlling the second switching element. The second control circuitry may be coupled to the first control circuitry. A reservoir element may be coupled to the first and second channels and configured to store a potential when one of the first and second channels supplies a respective first and second output voltage to the load element and to apply the potential to the load element when neither of the first and second output voltages is being supplied to the load element.

A method of switching a load channel in a device including a load element adapted to be supplied by a first load channel, a second load channel and a reservoir element may involve: supplying a first output voltage to the load element via the first load channel; supplying a voltage to the second load channel while the first output voltage is being supplied to the load element; discontinuing the supply of the first output voltage to the load element; supplying a second output voltage to the load element via the second load channel after discontinuing the supply of the first output voltage to the load element; and supplying a third output voltage to the load element from the reservoir element between the discontinuing of the supply of the first output voltage to the load element and the supplying of the second output voltage to the load element.

Another method of switching a load channel in a device having a load element and first and second load channels coupleable to the load element may involve: supplying a first output voltage to the load element via the first load channel from a first source; discontinuing the supply of the first output voltage to the load element if the first output voltage from the first source is below a predetermined value; and supplying a second output voltage to the load element via the second load channel from a second source before the discontinuing step.

### BRIEF DESCRIPTION OF THE DRAWINGS

The accompanying drawings, which are somewhat schematic in many instances, and are incorporated in and form a part of this specification, illustrate various details of the invention and, together with the description, serve to explain the principles of the invention.

FIG. 1 is a diagrammatic illustration of a conventional power source switch circuit for switching between a battery and an AC adaptor.

FIG. 2 is a diagrammatic illustration of a dual-channel load switch circuit in a device for switching between a battery and an AC adaptor as a power source for the device.

FIG. 3 is an illustration of a timing diagram for switching operations that may be performed by the circuit of FIG. 2. in a pulse width modulator for achieving a relatively narrow pulse.

### DETAILED DESCRIPTION OF EMBODIMENTS

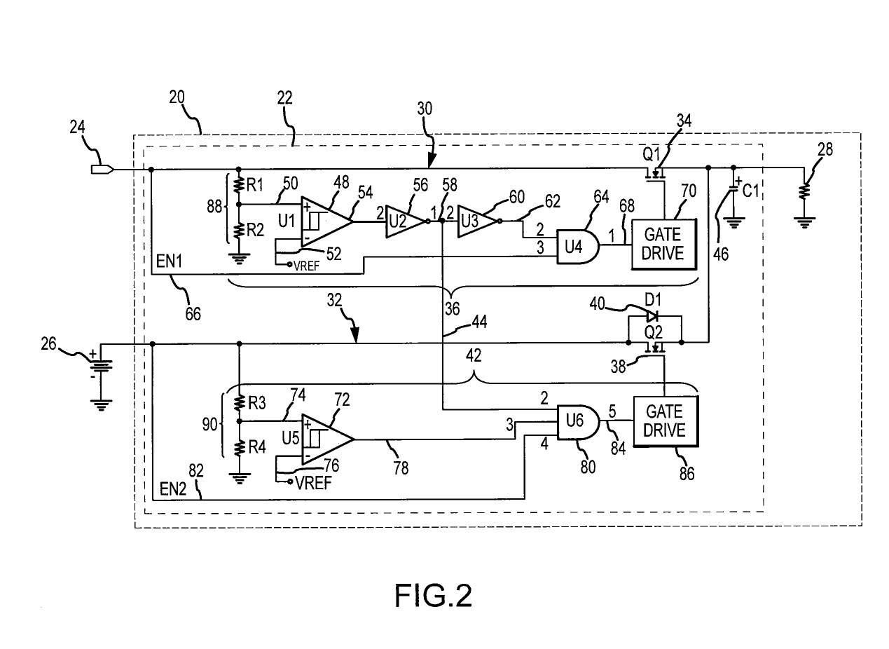

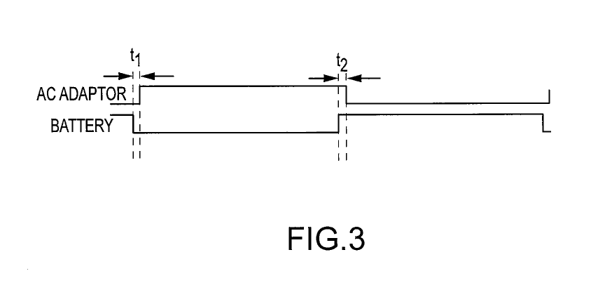

The circuit shown in FIG. 2 and the operational illustration shown in FIG. 3 are for illustration only and are not intended to represent the only possible configurations and operations. In particular, although a particular arrangement of circuit elements is illustrated in FIG. 2, it should be understood that any suitable arrangement of circuit elements may be envisioned to carry out the intended functions, and thus alternative and equivalent arrangements of elements is intended to be encompassed by the description. Further, it should be understood that various methods for switching power sources may be envisioned based on the following description. All details appurtenant to implementing the illustrated circuit and method that are well understood in the art are omitted for simplicity and clarity.

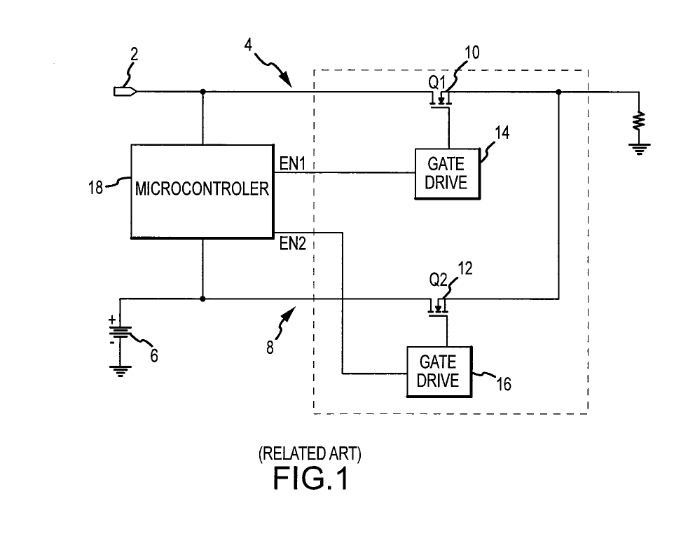

In a dual-channel load switch circuit such as discussed above with respect to FIG. 1, problems may be encountered. First, switchover between the two channels 4, 8 is not automatic. When the microcontroller 18 detects that the voltage from the AC power source 2 is lower than the threshold, the microcontroller 18 de-asserts the enable signal EN1 to turn off the first switch 10, disconnecting the AC power source 2 from the load element. However, the DC power source 6 does not become connected when this happens. The microcontroller 18 must still assert the enable signal EN2 to turn on the second switch 12, subsequently connecting the DC power source 6 to the load element. Thus, the switchover is not automatic, but depends on the microcontroller 18.

Second, a delay in switchover between the two channels 4, 8 may cause a power disruption to the load element. Accordingly, there may be a short period of time during which neither the AC power source 2 nor the DC power source 6 is connected to the load element. Undesirable consequences of a power disruption to the load element may include resetting the microcontroller 18. Assuming the AC adaptor provides power to the microprocessor, there are actually two possibilities: first, if the AC power is too low, either an external or an internal (to the microprocessor) reset circuit may suspend the operations of the microprocessor, which in turn may cause the outputs EN1 and EN2 to enter unknown states, and as such, the outputs can no longer control the gate drives 14, 16; second, if the AC power is suddenly removed, the microprocessor may lose power immediately, which may also cause the outputs EN1 and EN1 to enter unknown states, making them unable to control the gate drivers. The second possibility is not strictly a “reset” thing though. The same situation may also occur if the battery is used to power the microprocessor. As such, using a microprocessor is not a desirable way to control switching between two channels; rather, the microprocessor itself may be part of the load.

A part of a proposed solution to such problems is to provide automatic channel switchover. In particular, the microcontroller may be omitted entirely. Further, potential power disruption to the load element may be avoided by ensuring that a voltage is supplied to the load element during a time period in which neither power source is available or coupled to the load element. The circuits and methods contemplated herein provide an approach that automatically switches between channels to switch between power sources and supplies a voltage to the load element during the switchover to avoid a power disruption.

In one embodiment shown in FIG. 2, a device 20 is provided that includes a dual-channel load switch circuit 22 for switching between a first power source 24 and a second power source 26 for serving as power supplies to a load element 28 of the device 20. It should be understood that the device 20 may be any type of device that may be alternatively powered by two sources. While the first power source 24 may be an AC power source and the second power source 26 may be a DC power source, as shown, it should be understood that the first and second power sources may be of any suitable type according to the device 20 and may be substantially identical in some cases, such as providing redundant power sources. It should also be understood that the load element 28 of the device 20 may be any particular element or combination of elements that receive power, for example, voltage, to operate the device 20 or a function thereof.

The dual-channel load switch circuit 22 may include a first channel 30 adapted to receive a first input voltage from the first power source 24 and to supply a first output voltage to the load element 28 based on the first input voltage, and a second channel 32 adapted to receive a second input voltage from the second power source 26 and to supply a second output voltage to the load element 28 based on the second input voltage. The first channel 30 may include a first switching element 34 and first control circuitry 36 for controlling the first switching element 34. The second channel 32 may include a second switching element 38, a diode 40 in parallel with the second switching element 38 and second control circuitry 42 for controlling the second switching element 38. The second control circuitry 42 may be coupled to the first control circuitry 36 illustrated by a connection 44.

A reservoir element 46, such as a capacitor, may be coupled to the first and second channels 30, 32. In particular, the reservoir element may be connected between the load element 28 and the first and second channels 30, 32. As discussed below, the reservoir element 46 may be configured to store a potential when one of the first and second channels 30, 32 supplies a respective output voltage to the load element 28 and to apply the potential to the load element 28 when an output voltage is not being supplied to the load element 28 by either channel.

The first control circuitry 36 may include, as shown in FIG. 2, a first comparator 48 that is adapted to receive a first signal 50 based on the input voltage from the first power source 24 and to receive a first reference voltage 52. The first comparator 48 may be configured to compare the first signal 50 and the first reference voltage 52 to generate an output 54.

A first inverter 56 may be coupled to the first comparator 48 to receive the output 54. The first inverter 56 may be configured to generate an output 58 based on the received output 54, and may be coupled to the second control circuitry 42 via the connection 44 to provide the output 58 to the second control circuitry 42. The first inverter 56 may also be coupled to a second inverter 60 to provide the output 58 to the second inverter 60. The second inverter 60 may be configured to generate an output 62, and may be coupled to a first AND gate 64 to provide the output 62 to the AND gate 64.

The first AND gate 64 may be adapted to receive a first enable signal 66 based on the input voltage from the first power source 24. The first AND gate 64 may be configured to compare the output 62 from the second inverter 60 and the first enable signal 66 to generate an output 68. The first AND gate 64 may be coupled to a first switching element driver 70 to provide the output 68 thereto. The first switching element driver 70 thus may be configured to switch the first switching element 34 based on the output 68 from the first AND gate 64.

The second control circuitry 42 may include, as shown in FIG. 2, a second comparator 72 that is adapted to receive a second signal 74 based on the input voltage from the second power source 26 and to receive a second reference voltage 76. The second comparator 72 may be configured to compare the second signal 74 and the second reference voltage 76 to generate an output 78.

A second AND gate 80 may be coupled to the first control circuitry 36 via the connection 44 and to the second comparator 72. As such, the second AND gate 80 may be adapted to receive the output 58 from the first inverter 56 and to receive the output 78 from the second comparator 72. The second AND gate 80 may also be adapted to receive a second enable signal 82 based on the input voltage from the second power source 26. Thus, the second AND gate 80 may be configured to compare the output 58 from the first inverter 56, the output 78 of the second comparator 72 and the second enable signal 82 to generate an output 84. The second AND gate 80 may be coupled to a second switching element driver 86 to provide the output 84 thereto. The second switching element driver 86 thus may be configured to switch the second switching element 38 based on the output 84 from the second AND gate 80.

It should be understood that the first and second switching element drivers 70, 86 may be any suitable driver or controller, for example, based on the particular switching elements 34, 38 employed. For example, where integrated circuits such as a field-effect transistor or FET are employed, gate drivers may be used for the switching element drivers 70, 86. Suitable switching elements include, but are not limited to, an n-channel metal-oxide-semiconductor field-effect transistor or MOSFET as shown, a p-channel MOSFET, a bipolar transistor (NPN or PNP), an insulated-gate bipolar transistor IGBT or trench MOSFET.

The first control circuitry 36 may also include, as shown in FIG. 2, a resistor divider 88 coupled to the first comparator 48, adapted to receive the input voltage from the first power source 24, and configured to generate the first signal 50 based on the input voltage. Similarly, the second control circuitry 32 may also include a resistor divider 90 coupled to the second comparator 72, adapted to receive the input voltage from the second power source 26, and configured to generate the second signal 74 based on the input voltage. The resistor dividers 88, 90 may be used to divide down the input voltages from the first and second power sources 24, 26, as appropriate or desired. The resistor dividers 88, 90 provide a “divided down” voltage from either power source to be compared to a voltage VREF that is lower than the power source. Without the resistor dividers 88,90, the voltage of the non-inverting (+) input of the respective comparators would always be higher than the voltage of the inverting (−) input of the comparator, which would yield no switching.

It should be understood that the foregoing circuit elements, either individually or in combination, may be considered to respectively define the first and second control circuitry.

Operation of the dual-channel load switch circuit 22 shown in FIG. 2 may be as follows. It should be understood from this description that the dual-channel load switch circuit 22 allows automatic switching between power sources for the load element, as well as provides protection against power disruption to the load element during switching.

A first example is discussed with regard to a transition from the second power source 26, comprising a battery, to the first power source 24, comprising an AC adaptor. For the sake of simplicity, a same delay of t is assumed for each gate, that is, comparators 48, 72, inverters 56, 60, AND gates 64, 80. As will be understood from the following description, the switching or transition is automatic.

While the second power source 26 is providing an input voltage to the second channel 32 with the second switching element 38 on or closed so that a voltage is output to the load element 28 from the second channel 32, the first switching element 34 is off or open. When the first power source 24 is connected to the device 20 to couple to the first channel 30 and supplies an input voltage, the supplied input voltage is input to the resistor divider 88 coupled to the first comparator 48. The resistor divider 88 divides down the input voltage from the first power source 24 to generate the first signal 50, which is supplied to the first comparator 48. The first comparator 48 compares the first signal 50 against the first reference voltage 52.

The resistor divider 88 should be designed and the first reference voltage 52 should be selected, that is preset, so that when the input voltage from the first power source 24 is greater than a predetermined value or threshold the first signal 50 is greater than the first reference voltage 52. Thus, when the input voltage from the first power source 24 is greater than the predetermined value or threshold, the output 54 of the comparator 48 is a logic high. As the output 54 passes through the first inverter 56 and the second inverter 60, a delay of 2t is introduced.

The output 62 from the second inverter 60 is a logic high and is input to the first AND gate 64. The other input to the first AND gate 64 is the enable signal 66, which is also a logic high because it is tied to the input voltage from the first power source 24. The output 68 from the first AND gate 64 thus becomes a logic high after a delay of 3t, the aggregate delay introduced by the two inverters 56, 60 and the first AND gate 64. The logic high of the output 68 from the first AND gate 64 turns on or closes the first switching element 34 via the first switching element driver 70, which couples the first channel 30 to the reservoir element 46 and to the load element 28. Thus, the first power source 24 is connected to power the load element 28, for example, to apply an output voltage to the load element 28) after a delay of 3t.

As the output 54 of the comparator 48 is a logic high, the output 58 of the first inverter 56 becomes a logic low after a delay t (introduced by the first inverter 56 itself). Thus, the first inverter 56 provides a logic low input to the second AND gate 80. As noted above, the second power source 26 provides an input voltage to the second channel 32 with the second switching element 38 on or closed so that a voltage is output to the load element 28 from the second channel 32. As a result, at least the second enable signal 82 is a logic high input to the second AND gate 80. Thus, the second AND gate 80 provides a logic low as the output 84 after a delay of 2t, the aggregate delay introduced by the first inverter 56 and the second AND gate 80. Such logic low output 84 causes the second switching element driver 86 to turn off or open the second switching element 38 so as to decouple the second channel 30 from the reservoir element 46 and the load element 28. Thus, the second power source 26 is disconnected from the load element 28 after a delay of 2t.

Because the second switching element 38 is turned off or opened, after a delay of 2t, before the first switching element 34 is turned on or closed, after a delay of 3t, a short time period t₁ exists when both the first switching element 34 and the second switching element 38 are turned off or open. This is illustrated by the first transition shown in the timing diagram of FIG. 3. This avoids the potential problem of a reverse current flowing from the load element 28 to the second power source 26 once the first power source 24 is connected. For example, in the case of an AC adaptor as the first power source 24 and a battery as the second power source 26, a higher voltage of the AC adaptor may otherwise cause a reverse current that would potentially damage the battery, for example, if both power sources were connected simultaneously.

The short time period t when both the first switching element 34 and the second switching element 38 are turned off or open creates a potential power disruption to the load element 28. However, the diode 40 in parallel with the second switching element 38 and the reservoir element 46 are configured to avoid a power disruption during this short time period t.

In the initial condition noted above, the second power source 26 provides an input voltage to the second channel 32 and the second switching element 38 is on or closed. The second switching element 38 may be designed to have a very low voltage drop across it, that is, from the second power source 26 to the load element 28. In the case of an integrated circuit switching element, the on resistance between its drain and source may be very low. For example, with a current of one amp from the second power source to the load element, and an on resistance of 100 mili-ohms, the voltage drop across the second switching element is only 100 milivolts. The very low voltage drop across the second switching element 38, which is also the forward voltage of the diode 40, is not high enough to turn on the diode 40. Thus, as long as the second switching element 38 is on or closed and the second power source 26 is connected to the load element 28, there is no forward current through the diode 40 from the second power source 26 to the load element 28.

The reservoir element 46, in the case of a capacitor, is charged while the second switching element 38 is on or closed and the second power source 26 is connected to the load element 28. During the short time period t when both the first switching element 34 and the second switching element 38 are turned off or open as the transition from the second power source 26 to the first power source 24 is occurring, neither power source is available to the load element 28. The reservoir element 46 thus automatically begins discharging to the load element 28 to prevent a power disruption.

As the discharge voltage of the reservoir element 46 continues to drop, the discharge voltage drops to a level at which the forward voltage across the diode 40 becomes higher than its threshold voltage, which causes the diode 40 to be forward biased and turned on so as to reconnect the second power source 26 to the load element 28 through the diode 40. It is preferable that diode 40 is a fast diode that turns on as soon as possible after becoming forward biased. Such reconnection causes the reservoir element 46 to stop discharging with the voltage supplied to the load element 28 stabilizing at the voltage of the second power source minus the forward voltage drop across the diode 40. This reconnection ensures that the voltage supplied to the load element 28 does not drop to too low of a level that an undesirable power disruption condition on the load element 28 is triggered.

The second power source 26 continues to supply the output voltage to the load element 28 until the first switching element 34 is turned on or closed and the first power source 24 is connected to the load element 28. At that moment, with a higher voltage of the first power source 24, as compared to the voltage of the second power source 26, the voltage applied to the load element 28 rises to a level that causes the diode 40 to be reverse biased. This reverse bias prevents backward current flow from the load element 28 to the second power source 26. As the second switching element 38 is already off or open, no current from the load element 28 can flow backward to the second power source 26 via the second switching element 38 either. Thus, the second power source 26 is decoupled or disconnected, and preferably completely decoupled and disconnected, from the load element 28 and protected from damage by a reverse current.

A second example is discussed below with regard to a transition from the first power source 24 (AC adaptor) to the second power source 26 (battery) when the input voltage from the power source 24 drops below a preset value or threshold. While the first power source 24 provides an input voltage to the first channel 30 with the first switching element 34 on or closed so that a voltage is output to the load element 28 from the first channel 30, the second switching element 38 is off or open. When the input voltage from the first power source 24 drops below a preset value or threshold, the first signal 50 generated by the resistor divider 88 and input to the first comparator 48 becomes lower than the first reference voltage 52 and the output 54 of the first comparator 48 is a logic low. This causes the output 68 of the first AND gate 64 to be a logic low, causing the first switching element driver 70 to turn off or open the first switching element 34 and decoupling or disconnecting the first channel 30 from the load element 28 after a delay of 3t, introduced by the two inverters 56, 60 and the first AND gate 64.

The output 58 of the first inverter 56 becomes a logic high and is input to the second AND gate 80 via the connection 44. The second enable signal 82, which is also input to the second AND gate 80, is also a logic high. Thus, the second AND gate 80 provides a logic high as the output 84 after a delay of 2t, the aggregate delay introduced by the first inverter 56 and the second AND gate 80, causing the second switching element driver 86 to turn on or close the second switching element 38. Turning on or closing the second switching element couples or connects the second channel 30 to the load element 28. Thus, the second power source 26 is connected to the load element 28 after a delay of 2t.

Because the second switching element 38 is turned on or closed, after a delay of 2t, before the first switching element 34 is turned off or opened, after a delay of 3t, a short time period t₂ exists when both the first switching element 34 and the second switching element 38 are turned on or closed. This situation is illustrated by the second transition shown in the timing diagram of FIG. 3. Having both the first switching element 34 and the second switching element 38 are turned on or closed for the short time period t₂ avoids the potential problem of a power disruption to the load element 28. Further, because the voltage of the first power source 24 has dropped below the preset value or threshold, the voltage of the first power source 24 is less than the voltage of the second power source 26 and there is no reverse current from the load element 28 to the second power source 26.

A third example is discussed below with regard to a transition from the first power source 24, comprising an AC adaptor, to the second power source 26, comprising a battery. In this case, the power source 24 is disconnected and the input voltage therefrom is lost immediately, before the second power source 26 is connected to the load element 28. The reservoir element 46, which has been charged while the first power source 24 was connected to supply an output voltage to the load element 28, begins to discharge to the load element 28 to prevent any power disruption.

As the discharge voltage of the reservoir element 46 continues to drop, the discharge voltage drops to a level at which the forward voltage across the diode 40 becomes higher than its threshold voltage, which causes the diode 40 to be forward biased and turned on. As such, the diode 40 causes the second power source 26 to be connected to the load element 28 through the diode 40. This connection causes the reservoir element 46 to stop discharging and the voltage supplied to the load element 28 to stabilize at the voltage of the second power source 26 minus the forward voltage drop across the diode 40. In this manner, the voltage supplied to the load element 28 does not drop to a level that an undesirable power disruption condition on the load element 28 is triggered. Generally, “too low” means that the voltage may not be high enough for the load 28 to perform adequately. For example, supplying 2.8 volts to 3.3 volt load may be considered too low, although certain elements of the 3.3 volt load may still work with the 2.8 volts supplied.

The second power source 26 continues to supply the output voltage to the load element 28 through the diode 40 until the second switching element 38 is turned on or closed and the second power source 26 is connected to the load element 28 through the second switching element 38. As discussed above, because the voltage drop across the second switching element 38 is very low, the diode 40 does not have enough forward voltage to stay forward biased and thus turns off.

Although various details have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. A dual-channel load switch circuit for switching between first and second sources serving as a power supply to a load element and generating respective first and second input voltages, comprising:
a first channel adapted to receive the first input voltage and to supply a first output voltage to the load element based on the first input voltage, the first channel including a first switching element and first control circuitry for controlling the first switching element;
a second channel adapted to receive the second input voltage and to supply a second output voltage to the load element based on the second input voltage, the second channel including a second switching element, a diode in parallel with the second switching element and second control circuitry for controlling the second switching element, the second control circuitry being coupled to the first control circuitry; and
a reservoir element coupled to the first and second channels and configured to store a potential when one of the first and second channels supplies a respective first and second output voltage to the load element and to apply the potential to the load element when neither of the first and second output voltages is being supplied to the load element.

2. The circuit of claim 1, wherein the reservoir element includes a capacitor.

3. The circuit of claim 1, wherein the reservoir element is connected between the load element and the first and second channels.

4. The circuit of claim 1, further comprising an AC source as the first source and a DC source as the second source.

5. The circuit of claim 1, wherein the first control circuitry includes:
a first comparator adapted to receive a first signal based on the first input voltage and to receive a first reference voltage and configured to compare the first signal and the first reference voltage to generate an output;
a first inverter adapted to receive the output from the first comparator and configured to output a signal to the second control circuitry;
a second inverter adapted to receive the signal from the first inverter and configured to generate an output;
a first AND gate adapted to receive the output from the second inverter and to receive a first enable signal based on the first input voltage and configured to compare the output from the second inverter and the first enable signal to generate an output; and
a first switching element driver adapted to receive the output from the first AND gate and configured to switch the first switching element based on the output from the first AND gate.

6. The circuit of claim 5, further comprising a resistor divider coupled to the first comparator, adapted to receive the first input voltage, and configured to generate the first signal.

7. The circuit of claim 5, wherein the first enable signal is the first input voltage.

8. The circuit of claim 5, wherein the second channel includes:
a second comparator adapted to receive a second signal based on the second input voltage and to receive a second reference voltage and configured to compare the second signal and the second reference voltage to generate an output;
a second AND gate adapted to receive the signal from the first inverter and to receive the output of the second comparator and to receive a second enable signal based on the second input voltage and configured to compare the signal from the first inverter, the output of the second comparator and the second enable signal to generate an output; and
a second switching element driver adapted to receive the output from the second AND gate and configured to switch the second switching element based on the output from the second AND gate.

9. The circuit of claim 8, further comprising a resistor divider coupled to the second comparator, adapted to receive the second input voltage, and configured to generate the second signal based.

10. The circuit of claim 8, wherein the second enable signal is the second input voltage.

11. A portable device including a dual-channel load switch circuit for switching between first and second sources serving as a power supply and generating respective first and second inputs, comprising:
a load element;
a first channel adapted to receive the first input and configured to be coupled to the load element based on the first input, the first channel including a first switching element and first control circuitry for controlling the first switching element;
a second channel adapted to receive the second input and configured to be coupled to the load element based on the first input and the second input, the second channel including a second switching element, a diode in parallel with the second switching element and second control circuitry for controlling the second switching element, the second control circuitry being coupled to the first control circuitry; and
a reservoir element coupled to the first and second channels and configured to store a potential when one of the first and second channels supplies power to the load element and to apply the potential to the load element when neither of the first and the second channels supplies power to the load element.

12. A method of switching a load channel in a device including a load element adapted to be supplied by a first load channel, a second load channel and a reservoir element, comprising:
supplying a first output voltage to the load element via the first load channel;
supplying a voltage to the second load channel while the first output voltage is being supplied to the load element;
discontinuing the supply of the first output voltage to the load element;
supplying a second output voltage to the load element via the second load channel after discontinuing the supply of the first output voltage to the load element; and
supplying a third output voltage to the load element from the reservoir element between the discontinuing of the supply of the first output voltage to the load element and the supplying of the second output voltage to the load element.

13. The method of claim 12, wherein the step of supplying the first output voltage to the load element includes supplying the first output voltage from a DC source to the load element and the step of supplying the second output voltage to the load element includes supplying the second output voltage from an AC source.

14. The method of claim 12, wherein the step of supplying the first output voltage to the load element includes supplying from an AC source and the step of supplying the second output voltage to the load element includes supplying from a DC source.

15. The method of claim 12, wherein the step of supplying the third output voltage to the load element includes discharging the reservoir element.

16. The method of claim 15, wherein the step of supplying the first output voltage to the load element includes charging the reservoir.

17. The method of claim 12, further comprising resupplying the first output voltage to the load element when the third output voltage drops to a predetermined threshold.

18. The method of claim 17, wherein resupplying step includes forward biasing a diode.

19. A method of switching a load channel in a device having a load element and first and second load channels coupleable to the load element, comprising:
supplying a first output voltage to the load element via the first load channel from a first source;
discontinuing the supply of the first output voltage to the load element if the first output voltage from the first source is below a predetermined value; and
supplying a second output voltage to the load element via the second load channel from a second source before the discontinuing step.

20. The method of claim 19, wherein the first source is an AC source and the second source is a DC source.
